(19) United States
(12) Patent Application Publication
(10) Pub. No.: US 2026/0140020 A1
(43) Pub. Date: May 21, 2026

(54) SKIN-LIKE STRUCTURE-BASED INTELLIGENT MONITORING METHOD FOR INFRASTRUCTURE

(71) Applicant: TONGJI UNIVERSITY, SHANGHAI (CN)

(72) Inventors: GANG LI, SHANGHAI (CN); MENG ZHANG, SHANGHAI (CN); BIN HE, SHANGHAI (CN); RUNJIE SHEN, SHANGHAI (CN)

(21) Appl. No.: 19/396,659

(22) Filed: Nov. 21, 2025

(30) Foreign Application Priority Data
Nov. 21, 2024 (CN) 202411673510.5

(51) Int. Cl. G01M 99/00

(52) U.S. Cl. CPC G01M 99/00

(57) ABSTRACT

A skin-like structure-based intelligent monitoring method for infrastructure includes: acquiring infrastructure data from multiple sensor nodes in the sensor network; constructing a spatiotemporal correlation model according to the infrastructure data from the multiple sensor nodes, and distinguishing the property of each sensor node in the sensor network according to the spatiotemporal correlation model; inputting the temporal feature and spatial feature of the spatiotemporal correlation model into the conditional variational autoencoder (CVAE) model to determine the risk coefficient of each sensor node; and performing visualization processing on the structural health state of the infrastructure according to the risk coefficient of each sensor node, and adjusting the infrastructure monitoring work of the sensor network according to the risk coefficient of each sensor node and the property of each sensor node.

### CROSS REFERENCE TO RELATED APPLICATIONS

The present disclosure claims the priority to the Chinese patent application with the filing No. 202411673510.5, entitled “SKIN-LIKE STRUCTURE-BASED INTELLIGENT MONITORING METHOD FOR INFRASTRUCTURE” and filed on Nov. 21, 2024 with the Chinese Patent Office, the contents of which are incorporated herein by reference in their entirety.

### TECHNICAL FIELD

The present disclosure relates to the technical field of Internet of Things in civil engineering, and particularly to a skin-like structure-based intelligent monitoring method for infrastructure.

### BACKGROUND ART

With the acceleration of urbanization process, the safety and durability of infrastructure have become a focus of social attention. Wireless sensor networks, due to their characteristics such as low cost, large-scale detection, and easy deployment, have become one of the important tools for skin-like structure-based intelligent monitoring of infrastructure. However, traditional structural health monitoring methods still have shortcomings in aspects such as data processing, feature extraction, and health state assessment, making it difficult to meet the requirements for comprehensive understanding and accurate prediction of complex structural data. Furthermore, the structural health monitoring of infrastructure faces problems such as difficulty in sensor installation, high energy consumption during long-term operation, and strong data heterogeneity, which limit the widespread application of wireless sensor networks in the field of structural health monitoring.

### SUMMARY

To solve the technical problems in prior art that it is difficult to meet the requirements for comprehensive understanding and accurate prediction of complex structural data, embodiments of the present disclosure provide a skin-like structure-based intelligent monitoring method and system for infrastructure. The technical solutions are as follows.

In an aspect, a skin-like structure-based intelligent monitoring method for infrastructure is provided, and the method is implemented by a skin-like structure-based intelligent monitoring device for infrastructure, and the method includes:
S1. acquiring infrastructure data from multiple sensor nodes in a sensor network;
S2. constructing a spatiotemporal correlation model according to the infrastructure data from the multiple sensor nodes, and distinguishing the property of each of the sensor nodes in the sensor network according to the spatiotemporal correlation model;
S3. inputting the temporal feature and spatial feature of the spatiotemporal correlation model into a conditional variational autoencoder (CVAE) model to determine the risk coefficient of each sensor node; and
S4. performing visualization processing on the structural health state of the infrastructure according to the risk coefficient of each sensor node, and adjusting the infrastructure monitoring work of the sensor network according to the risk coefficient of each sensor node and the property of each sensor node.

In another aspect, a skin-like structure-based intelligent monitoring system for infrastructure is provided, the system applies the skin-like structure-based intelligent monitoring method for infrastructure, and the system includes:
a data base layer, which is used to acquire infrastructure data from multiple sensor nodes in the sensor network;
a connection structure layer, which is used to construct a spatiotemporal correlation model according to the infrastructure data from the multiple sensor nodes, and distinguish the property of each of the sensor nodes in the sensor network according to the spatiotemporal correlation model; and
a pathological manifestation layer, which is used to input the temporal feature and spatial feature of the spatiotemporal correlation model to the conditional variational autoencoder (CVAE) model to determine the risk coefficient of each sensor node; and perform visualization processing on the structural health state of the infrastructure according to the risk coefficient of each sensor node, and adjust the infrastructure monitoring work of the sensor network according to the risk coefficient of each sensor node and the property of each sensor node.

In another aspect, a skin-like structure-based intelligent monitoring device for infrastructure is provided, where the skin-like structure-based intelligent monitoring device for infrastructure includes: a processor, and a memory, where the memory stores computer-readable instructions, and when the computer-readable instructions are executed by the processor, any one of the skin-like structure-based intelligent monitoring methods for infrastructure above is implemented.

In another aspect, a computer-readable storage medium is provided, where at least one instruction is stored in the storage medium, the at least one instruction is loaded and executed by a processor to implement any one of the skin-like structure-based intelligent monitoring methods for infrastructure above.

The beneficial effects of the technical solutions provided by the embodiments of the present disclosure include at least that:
the present disclosure employs a temporal convolutional network and a dimensionally isolated graph attention network to construct spatiotemporal correlations, and uses a conditional variational autoencoder to perform data fusion, and simultaneously proposes a multi-granularity perceptual map adjustment strategy to adapt to monitoring requirements under different safety conditions, thereby achieving an energy-saving effect; the present disclosure may effectively perform structural health assessment, featuring high accuracy, intuitiveness, and low energy consumption, extending the service life of sensor networks; and furthermore, the present disclosure further proposes a multi-granularity perceptual map adjustment strategy, which may dynamically adjust the monitoring granularity according to actual monitoring requirements and further improve the flexibility and adaptability of monitoring.

### BRIEF DESCRIPTION OF DRAWINGS

In order to more clearly illustrate the technical solutions in the embodiments of the present disclosure, the drawings required for use in the description of embodiments or the prior art will be briefly introduced below. Obviously, the drawings described below are only some embodiments of the present disclosure. For a person ordinarily skilled in the art, other drawings may be obtained based on the provided drawings without paying creative work.

FIG. 1 is a structural schematic view of a skin-like structure-based intelligent monitoring system for infrastructure provided in embodiments of the present disclosure;

FIG. 2 is a flowchart of a skin-like structure-based intelligent monitoring method for infrastructure provided in embodiments of the present disclosure;

FIGS. 3A-3D are schematic views of the effects presented by the pathological manifestation layer in an application example provided by embodiments of the present disclosure;

FIG. 4 is a block diagram of a skin-like structure-based intelligent monitoring system for infrastructure provided in embodiments of the present disclosure; and

FIG. 5 is a structural schematic view of a skin-like structure-based intelligent monitoring device for infrastructure provided in embodiments of the present disclosure.

### DETAILED DESCRIPTION OF EMBODIMENTS

The technical solutions of the present disclosure will now be described with reference to the drawings.

In embodiments of the present disclosure, words such as “exemplarily” and “for example” are used to indicate serving as an example, illustration, or description. Any embodiments or design solutions described as an “example” in the present disclosure should not be construed as being more preferred or advantageous than other embodiments or design solutions. Specifically, the use of the word “example” is intended to present a concept in a concrete manner. Furthermore, in embodiments of the present disclosure, the meaning expressed by “and/or” may be both, or either one of the two.

In the embodiments of the present disclosure, the terms “image” and “figure” may sometimes be used interchangeably. It should be noted that when their differences are not emphasized, the meanings they intend to express are consistent. The terms “of,” “corresponding, relevant” and “corresponding” may sometimes be used interchangeably. It should be noted that when their differences are not emphasized, the meanings they intend to express are consistent.

In the embodiments of the present disclosure, sometimes subscripts such as W₁ may be written in a non-subscript form such as W₁. When their differences are not emphasized, the meanings they intend to express are consistent.

To make the technical problems, technical solutions and advantages of the present disclosure clearer, detailed description will be given below in conjunction with the drawings and specific embodiments.

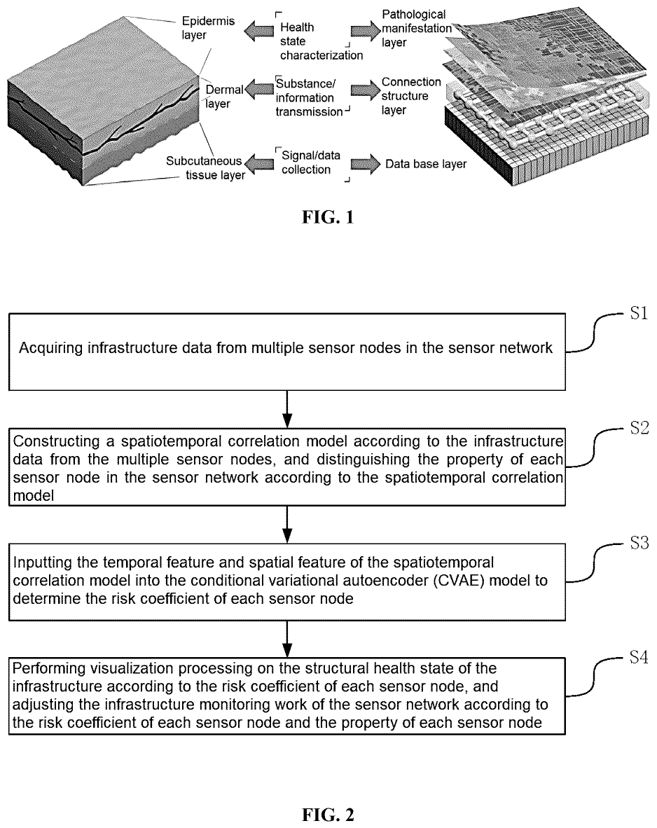

Embodiments of the present disclosure provide a skin-like structure-based intelligent monitoring method for infrastructure, the method may be implemented by a skin-like structure-based intelligent monitoring system for infrastructure, and the skin-like structure-based intelligent monitoring system for infrastructure improves the accuracy and intuitiveness of wireless sensor networks (WSNs) in structural health monitoring by imitating the multi-layer structure of biological skin. As shown in FIG. 1, the skin-like structure-based intelligent monitoring system for infrastructure includes three main layers: a data base layer, a connection structure layer, and a pathological manifestation layer. The data base layer is equivalent to the subcutaneous tissue layer, and is used to perform signal or data acquisition; the connection structure layer is equivalent to the dermal layer, and is used to transmit substances or information; and the pathological manifestation layer is equivalent to the epidermis layer, and is used to characterize health state. This method is applicable to the structural health monitoring of various infrastructures, including but not limited to buildings, bridges, and tunnels, etc. FIG. 2 shows a flowchart of the skin-like structure-based intelligent monitoring method for infrastructure, and the processing flow of the method may include the following steps.

S1. Acquiring infrastructure data from multiple sensor nodes in the sensor network.

Optionally, the specific operation of S1 may include the following steps S11-S12.

S11. Acquiring data from different types of sensor nodes in the sensor network.

In one feasible implementation, the data base layer is responsible for collecting data from different types of sensors, which are evenly distributed in key parts of the infrastructure, such as load-bearing columns and crossbeams. The types of the sensors include, but not limited to, support force sensors, torsional force sensors, displacement sensors, and water seepage sensors, etc. The sensors transmit data to the central processing unit via wireless communication techniques such as WiFi and ZigBee.

S12. Performing preprocessing on the collected data to obtain the infrastructure data.

In one feasible implementation, the collected data first undergoes a preprocessing step, including data cleaning, format unification, and preliminary filtering, to remove invalid or erroneous data points and ensure the accuracy and reliability of subsequent processing.

S2. Constructing a spatiotemporal correlation model according to the infrastructure data from the multiple sensor nodes, and distinguishing the property of each of the sensor nodes in the sensor network according to the spatiotemporal correlation model.

Optionally, the specific operation of S2 may include the following steps S21-S22.

S21. Constructing the spatiotemporal correlation model by using a method combining a temporal convolutional network and a dimensionally isolated graph attention network, according to the infrastructure data from multiple sensor nodes.

Optionally, the specific operation of S21 may include the following steps;

S211. generating time series data according to data from multiple sensor nodes, inputting the time series data into the temporal convolutional network, and capturing temporal feature vectors at different time scales through multiple causal convolution layers in the temporal convolutional network, and

S212. combining the temporal feature vectors with the original spatial data in the data from the multiple sensor nodes to obtain a new feature matrix, inputting the new feature matrix into a dimensionally isolated graph attention network, calculating the weights between the nodes according to the multi-head attention mechanism in the graph attention network, and calculating the attention coefficients between each node and all adjacent nodes thereof, thereby obtaining the spatiotemporal correlation between nodes.

In one feasible implementation, the connection structure layer extracts the spatiotemporal relationships between the sensor nodes by constructing a spatiotemporal correlation model. The present disclosure adopts a method combining a temporal convolutional network (TCN) and a dimensionally isolated graph attention network (GAT), where the TCN is used to capture long-term dependencies in time series data, while the GAT is used to capture correlations between the nodes in spatial data. Through this combination, spatiotemporal features may be extracted more effectively, providing a solid foundation for health assessment. The specific construction process is described below:
first, inputting the time series data collected from the data base layer to the TCN module, where multiple causal convolution layers are designed in the TCN module, with the kernel size (size of the convolution kernel) increasing progressively in the layers to capture features at different time scales, and simultaneously, residual blocks are added after each layer;
where after processing by the TCN module, the obtained temporal feature vector is combined with the original spatial data to form a new feature matrix, and the feature matrix is transmitted as an input to the graph attention network (GAT) module; in the GAT module, an undirected graph is defined, where each sensor node corresponds to a vertex, and the edge weights reflect the spatial correlation between nodes; each node (i.e., the sensor) considers not only its own features but also performs weighted aggregation according to the features of its neighboring nodes, where the weights are obtained through automatic learning of the attention mechanism; GAT calculates the weights between nodes through a multi-head attention mechanism, and specifically, for each node i, the attention coefficients au, between it and all adjacent nodes j thereof are calculated, where the coefficient reflects the degree of influence of node j on node i; and the calculation formula is as follows:

$${α}_{ij} = \frac{exp ( Leaky ReLU ( {\vec{a}}^{T} [ W \vec{{h}_{i}} ‖ W {\vec{h}}_{j} ] ) )}{{\sum }_{v ∈ {N}_{1}} exp ( Leaky ReLU ( {\vec{a}}^{T} [ W \vec{{h}_{i}} ‖ W {\vec{h}}_{v} ] )}$$

where \vec{a} indicates the learning parameter of the attention mechanism, W indicates the linear transformation matrix, \vec{h}ᵢ, \vec{h}ⱼ and \vec{h}ᵥ indicate the feature vectors of nodes i, j, and v, respectively, and Nᵢ indicates the set of adjacent nodes of the node i, and ∥ indicates a vector concatenation operation; and
finally, the spatiotemporal correlation between nodes is obtained after GAT processing.

S22. Determining the affiliation value and dominance value of each sensor node according to the attention coefficients between the nodes in the spatiotemporal correlation model and the information of adjacent nodes of each sensor node, and distinguishing dominance nodes, affiliation nodes, and independence nodes in the sensor network.

Optionally, the specific operation of S22 may include the following steps S221-S222.

S221. Calculating the first-order affiliation value of the i-th sensor node in the sensor network according to the following formula (1), and calculating the first-order dominance value of the i-th sensor node according to the following formula (2):

$$aff {( i )}_{1} = \frac{{\sum }_{j = 0}^{N} {α}_{ij}}{N} \qquad ( 1 )$$

$$dom {( i )}_{1} = \frac{{\sum }_{j = 0}^{N} {α}_{ji}}{N} \qquad ( 2 )$$

where aff(i)₁ indicates the first-order affiliation value of the i-th sensor node in the sensor network, αᵢⱼ indicates the attention coefficient between the i-th sensor node and the j-th sensor node in the sensor network, where i is not equal to j, N indicates the total number of first-order adjacent nodes of the i-th sensor node, dom(i), indicates the first-order dominance value of the i-th sensor node in the sensor network, and αⱼᵢ indicates the attention coefficient between the j-th sensor node and the i-th sensor node.

In one feasible implementation, which nodes play a key dominant role in structural health monitoring is determined by calculating the attention coefficients between nodes. The selection of dominance nodes is based on their degree of influence on surrounding affiliation nodes, and these dominance nodes are usually located at critical positions of the structure, such as main beam joints or structural deformation sensitive areas.

The dominance point (dominance node) distribution matrix is derived from the attention coefficients between the nodes to obtain the dominance node information. First, two parameter values are calculated for each node, namely the affiliation value and the dominance value respectively, where the affiliation indicates the condition to which the node is influenced by its adjacent nodes, and a node has higher affiliation if the own features thereof fluctuate due to changes in surrounding nodes; a node has higher dominance if the changes in the own features thereof easily cause fluctuations in the features of surrounding nodes; and in addition to the above two cases, a node has higher independence if the changes in own features thereof do not easily cause fluctuations in the features of surrounding nodes and the node is also not prone to feature fluctuations due to changes in surrounding nodes. For the first-order close neighbors of the i-th node, the calculation methods of the two attributes are respectively as shown in the above formulas (1) and (2).

It should be noted that the above steps calculate the affiliation value and dominance value of the i-th node with respect to its first-order close neighbors; and to further expand the adjustable range of the node network granularity, when the affiliation value and dominance value of the i-th node exceed a certain threshold value λ, the order of the close neighbor calculation for the i-th node is expanded to M-th order until both its affiliation value and dominance value are below the threshold value λ, where the calculation methods are as shown in the following formulas (3) and (4):

$$aff {( i )}_{M} = \frac{{\sum }_{m = 1}^{M} {\sum }_{j = 0}^{N} {α}_{ij}}{{2}^{M - 1} N} \qquad ( 3 )$$

$$dom {( i )}_{M} = \frac{{\sum }_{m = 1}^{M} {\sum }_{j = 0}^{N} {α}_{ji}}{{2}^{M - 1} N} \qquad ( 4 )$$

Through the above calculation, the affiliation value, dominance value, and expandable close neighbor order of each node may be obtained, where the expanded close neighbor order M for dominance value indicates the maximum granularity that the node may cover, and the nodes within its coverage may be uniformly represented by the features of the node, and correspondingly, the order M for affiliation value indicates the maximum granularity at which the node may be represented by nearby nodes. It is worth noting that the coverage range of node granularity may be artificially intervened by changing the threshold value λ; that is to say, the model allows the involvement of prior knowledge to adjust the granularity size. The node whose dominance value reaches the granularity is invoked at different granularity order to approximately represent the neighboring nodes within the coverage range thereof that have the granularity affiliation, and the node whose dominance value cannot reach the granularity is still characterized by the original value thereof, thereby enabling the construction of the multi-granularity perceptual map correlation layer.

S222. Determining the i-th sensor node as an affiliation node, if the first-order affiliation value of the i-th sensor node is greater than or equal to the first attribute threshold value; determining the i-th sensor node as a dominance node, if the first-order dominance value of the i-th sensor node is greater than or equal to the second attribute threshold value; and determining the i-th sensor node as an independence node, if the first-order affiliation value of the i-th sensor node is less than the first attribute threshold value and the first-order dominance value is less than the second attribute threshold value.

S3. Inputting the temporal feature and spatial feature of the spatiotemporal correlation model to the conditional variational autoencoder (CVAE) model to determine the risk coefficient of each sensor node.

Optionally, the training process of the conditional variational autoencoder (CVAE) model includes:
acquiring a training sample, where the training sample includes infrastructure-related sample input data and the label information corresponding to the sample input data; and
inputting the sample input data to the CVAE model to be trained, to obtain the corresponding mean and variance of the sample input data, determining a predicted latent variable according to the mean and variance, comparing the predicted latent variable with the label information corresponding to the sample input data and calculating the loss function, and adjusting the parameters in the CVAE model to be trained, performing iterative execution until the loss function converges, and then stopping training to obtain a trained conditional variational autoencoder (CVAE) model.

In one feasible implementation, the loss function of CVAE consists of two parts: reconstruction error and KL divergence. The two parts together constitute the objective function of CVAE, aiming to minimize the difference between the input data and its reconstructed version, and simultaneously ensuring that the latent variable distribution is close to the prior distribution.

p_{θ}(x|z,y) is the probability distribution of input data reconstructed from the latent variable z and the conditional label y, thus the reconstruction error may be expressed as:

$${L}_{rec} = - {E}_{{q}_{ϕ} ( z \vert x , y )} [ log {p}_{θ} ( x \vert z , y ) ]$$

where q_{φ}(z|x) indicates the encoder distribution.

The KL divergence is used to measure the difference between the posterior distribution output by the encoder and the prior distribution. It is usually desired that the posterior distribution is as close as possible to the prior distribution, which helps preserve favorable properties of the latent space, such as smoothness and continuity. The KL divergence may be expressed as:

$${D}_{KL} = \frac{1}{2} \sum ( 1 + log ( {σ}^{2} ) - {μ}^{2} - {σ}^{2} )$$

where μ and σ are the mean and standard deviation of the latent variable z output by the encoder, respectively.

Optionally, the specific operation of S3 may include the following steps S31-S32:
S31. obtaining time series data according to the temporal feature and spatial feature of the spatiotemporal correlation model, and generating input information in a preset format according to the time series data, where the preset format is (sensor ID, time, data type); and
S32. inputting the input information to the trained conditional variational autoencoder (CVAE) model, and determining the risk coefficient of the corresponding sensor node according to the output latent variable, where the latent variable is used to characterize the mechanical property, material strength property and dynamic characteristic of the foundation structure in different dimensions.

Optionally, the specific operation of S32 may include the following steps S321-S324;
S321. performing feature extraction and dimensionality reduction on the multi-source heterogeneous sensor data by using a conditional variational autoencoder to obtain a node risk coefficient, which is used to characterize the health state of the sensor node;
S322. extracting the main influence factors of the structural health state by using the latent variable calculation method of the conditional variational autoencoder, combined with prior knowledge of the physical characteristics of infrastructure;
S323. determining the spatial distribution condition of the risk coefficient of each node by constructing a normal distribution mode, with the mean and variance output by the conditional variational autoencoder as the quantitative indicators of the health state of the node; and
S324. calculating the risk coefficient of each node, measuring the probability distribution difference between the risk coefficient of the node and the risk coefficient under an ideal condition by using the Hellinger distance, so as to assess the health states of the nodes.

In one feasible implementation, the pathological manifestation layer converts the spatiotemporal features extracted by the connection structure layer into a visual representation of structural health state by using a health assessment algorithm. The embodiments of the present disclosure employ a conditional variational autoencoder (CVAE) to fuse heterogeneous data, where the CVAE may map different types of sensor data to a common low-dimensional space, thereby extracting key features reflecting the structural health state. By training the CVAE model, the risk coefficient for each node may be obtained, and used to quantify the health state of the node.

The input format of the time series data received from the sensors is (sensor ID, time, data type). Then, for ease of processing, the data is segmented as needed, resulting in a data sequence with a three-dimensional tensor as input, x∈R^{n×d×ω}, where n indicates the number of sampling points contained in each time period, d indicates different sensor node, and ω indicates different sensor types. What needs to be done in the health state assessment section is to determine a three-dimensional risk coefficient according to the input data x, to characterize the overall safety state of the entire infrastructure at this moment, where the overall safety state is obtained by taking the average of the safety state of each node.

A method of a conditional variational autoencoder is employed to perform feature extraction and dimensionality reduction on information from multi-source heterogeneous sensors, and the node risk coefficient obtained through dimensionality reduction is used to characterize the health state of sensor nodes. The conditional variational autoencoder is obtained by improving an autoencoder, and the principle of the autoencoder is briefly introduced below.

An autoencoder, which is a generative model, converts high-dimensional original information into low-dimensional latent variables through an encoder to store key information and then reconstructs the latent variables back into the original information through a decoder, where during the conversion process, to ensure the continuity of latent variable generation, the model adds additional constraints to the latent variables, for example, the latent variables need to follow a Gaussian distribution during generation. From a perspective of probability theory, the generation process of VAE is as follows: a series of latent variables z are generated from prior distribution p_{θ}(z), and the generation results \hat{x} are generated from generative distribution p_{θ}(x|z), where z follows p_{θ}(z), and x follows p_{θ}(x|z). Generally speaking, parameter estimation for directed graph models is relatively difficult, while VAE effectively evaluates parameter accuracy by using stochastic gradient variational Bayes; and specifically, the variational lower bound is used as a surrogate objective function, and the variational lower bound is as follows:

$$log {p}_{θ} ( x ) = KL {( {q}_{ϕ} ( z \vert x ) ‖ {p}_{θ} ( z \vert x ) )}_{( z \vert x )} + {E}_{{q}_{ϕ} ( z \vert x )} [ - log {q}_{ϕ} ( z \vert x ) + log {p}_{θ} ( x , z ) ] \geq - KL ( {q}_{ϕ} ( z \vert x ) ‖ {p}_{θ} ( z ) ) + {E}_{{q}_{ϕ} ( z \vert x )} [ log {p}_{θ} ( x \vert z ) ]$$

In VAE, the encoder model uses an approximate distribution q_{φ}(z|x) to estimate the accurate actual posterior probability p_{θ}(z|x), both the encoder and decoder employ a multilayer perceptron as the training network structure; since the first term of its variational lower bound, the KL divergence, may be marginalized, while the second term cannot, the second term is obtained by means of sampling the latent variable z through approximate distribution q_{φ}(z|x); and the actual VAE objective function is transformed into the following formula:

$${\tilde{L}}_{VAE} ( x ; θ , ϕ ) = - KL ( {q}_{ϕ} ( z \vert x ) ‖ {p}_{θ} ( z ) ) + \frac{1}{L} {\sum }_{l = 1}^{L} log {p}_{θ} ( x \vert {z}^{( l )} ) ,$$

where z^{(I)}=g_{φ}(x,ε^{(I)}),ε^{(I)}˜N(0,I), the encoding distribution q_{φ}(z|x) is reparameterized by a determined differentiable function g, its parameters are the input x and the noise variable E, enabling errors to be backpropagated through Gaussian latent variables and thus allowing VAE to be effectively trained by using the method of stochastic gradient descent.

VAE is an unsupervised clustering method with some feature extraction and dimensionality reduction capabilities, but the distinguishability between different categories is often not obvious during dimensionality reduction, so some label information is added to assist the model in discrimination. The implementation process of the conditional variational autoencoder (CVAE) is as follows: for a given input x, the latent variable z is obtained through prior distribution p_{θ}(z|x), and the output y is obtained through distribution p_{θ}(y|x,z). The training objective of the CVAE is to maximize the conditional probability, the handling of the variational lower bound is the same as that of VAE, and its variational lower bound is:

$$log {p}_{θ} ( y \vert x ) \geq - KL ( {q}_{ϕ} ( z \vert x , y ) ‖ {p}_{θ} ( z \vert x ) ) + {E}_{{q}_{ϕ} ( z \vert x , y )} [ log {p}_{θ} ( y \vert x , z ) ]$$

The evidence lower bound is:

$${\tilde{L}}_{CVAE} ( x , y ; θ , ϕ ) = - KL ( {q}_{ϕ} ( z \vert x , y ) ‖ {p}_{θ} ( z \vert x ) ) + \frac{1}{L} {\sum }_{l = 1}^{L} log {p}_{θ} ( y \vert x , {z}^{( l )} ) ,$$

where

$${z}^{( I )} = {g}_{φ} ( x , y , {ε}^{( I )} ) , {ε}^{( I )} ∼ N ( 0 , I ) ,$$

L is the number of samples.

The conditional variational autoencoder is typically used for processing the tasks such as image classification and image object extraction, but in the present disclosure, the goal is transformed to extracting features from input time period data and mapping them to a new feature dimension with smooth transitions; therefore, feature label information y is added on the basis of the original data x∈R^{n×d×ω}, the label information is obtained from prior knowledge of the physical characteristics of the infrastructure, y has the same dimension as the latent variable z, and characterize the mechanical property, material strength property, and dynamic characteristic of the structure in different dimensions.

The mechanical property is mainly related to supporting force, tensile force, and torsional force, and the abrupt change in the mechanical property may reflect physical properties such as structural cracking and internal mechanical damage; the material strength property is mainly related to the information of leakage water, temperature, and humidity, and may reflect the slow changes in the inherent material properties of infrastructure materials under long-term environmental variations; the dynamic characteristic is mainly related to information such as the velocity and acceleration of structural displacement and torsion, and wide-ranging change in dynamic characteristic easily causes damage to the structural safety of infrastructure. The feature label information y is applied as a variational condition to the CVAE model to guide the model input x to map in the direction towards the label, achieving the purpose of multi-source data fusion feature extraction.

The quantification of the risk coefficients includes the health indices and their confidence information of the sensor nodes in three dimensions: mechanical property, material strength property, and dynamic characteristic.

The latent variable is a three-row one-column (3×1) feature vector, where the values in the first, second, and third rows represent the health indices in the three dimensions of mechanical property, material strength property, and dynamic characteristic, respectively.

It should be noted that the latent variable z is obtained by sampling the mean μ and variance σ obtained by processing the model input x through the encoder, while the latent feature variable that may reflect the input data x should be the mean μ output by the encoder, and similarly, the mean μ has the same dimension as the model label y. After each sensor unit collects data, the encoder part of the CVAE performs local computation to obtain the mean μ and variance σ, and only the mean and variance information needs to be transmitted to the processing unit, and then the original data condition may be recovered through the decoder in the processing unit. This method may significantly reduce the frequency of data transmission and the total amount of information, and improve the security of information transmission.

S4. Performing visualization processing on the structural health state of the infrastructure according to the risk coefficient of each sensor node, and adjusting the infrastructure monitoring work of the sensor network according to the risk coefficient of each sensor node and the property of each sensor node.

Optionally, the specific operation of S4 may be as follows.

When the risk coefficient of each sensor node in the sensor network is less than the preset risk threshold value, it is determined that all areas of the infrastructure are in a safety state at the current moment, the activated states of the dominance nodes and independence nodes are maintained, and the affiliation nodes are put into a dormant state.

When the risk coefficients of some sensor nodes in the sensor network are greater than or equal to the preset risk threshold value, it is determined that some areas of the infrastructure are in a dangerous state at the current moment, the affiliation nodes dominated by the dominance nodes in the dangerous state are activated, the affiliation nodes in the dangerous state are activated, and the activated states of the independence nodes in the dangerous state are maintained.

In one feasible implementation, to adapt to the monitoring requirements under different safety conditions, the embodiments of the present disclosure propose a multi-granularity perceptual map adjustment strategy. Under good safety conditions, most nodes (referred to as affiliation nodes) are in a dormant state, and only the dominance nodes and independence nodes remain active, thereby reducing system energy consumption. When deterioration in structural health condition is detected, the system may automatically wake up more nodes in the affected area(s), to increase the monitoring frequency and density to provide more detailed health state information. This method may not only enhance the flexibility and adaptability of monitoring, but also effectively extend the life cycle of the sensor network.

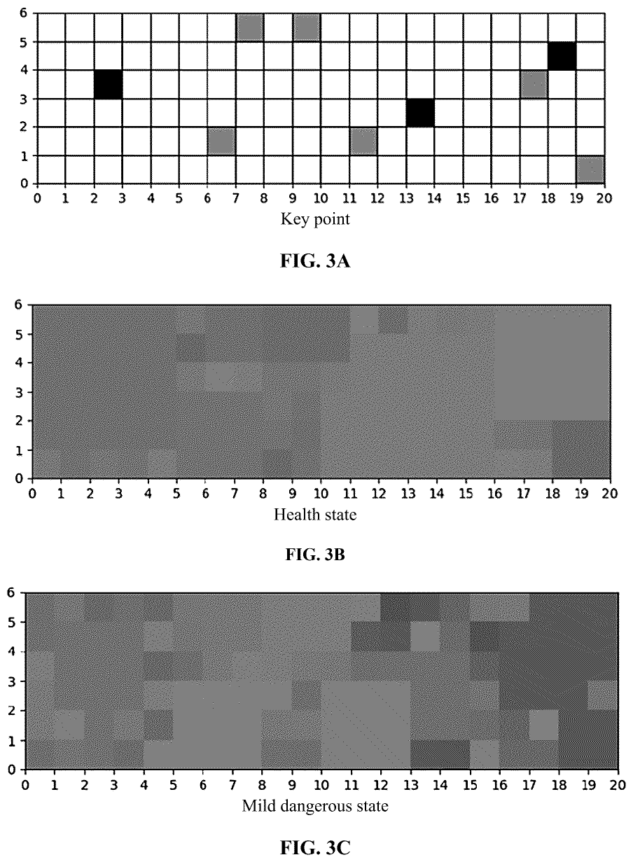

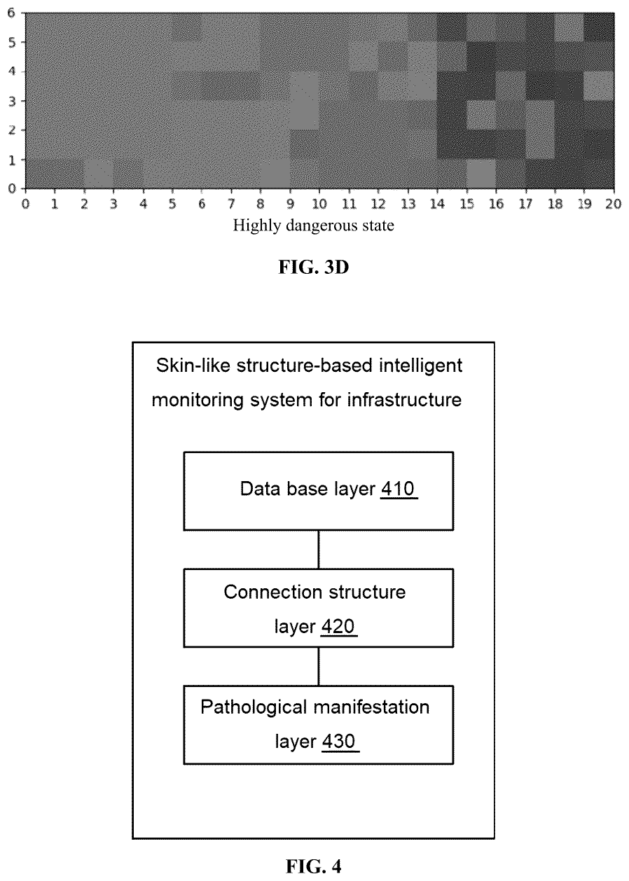

To further illustrate the effect of the method described in the present disclosure, FIGS. 3A-3D show schematic views of the effects presented by the pathological manifestation layer in an application example. In this example, 20 consecutive point (node) data in the tunnel are selected. Since the sensors are arranged in an annular pattern in the tunnel, data collected by the sensors within the same circular section may be flattened into a plane for analysis, where there are six sensor points in each annular section. 120 sensor points are selected for the analysis of the perceptual map granularity adjustment strategy. First, the data collected by the wireless sensor network (WSN) for tunnel structure monitoring is input into the connection structure layer to construct a dimension-independent spatial feature model, to obtain the spatial correlation information between sensor nodes, and the nodes with first-order and second-order dominance are obtained through calculation to form a multi-granularity key node map. As shown in FIG. 3A, there are three nodes with second-order dominance, the coordinates of which are [3, 2], [2, 13], and [4, 18], respectively. These nodes all exhibit high dominance over nodes within the two adjacent grids nearby, meaning that changes in point data of the sensors within the two grids are all reflected in the changes of data collected by such nodes. Such nodes are typically located at key positions such as main beams and inter-segment joints, which are also key observation points in traditional monitoring fields, indicating the consistency between the method proposed in the embodiments of the present disclosure and practical situations. There are six nodes with first-order dominance, the coordinates of which are [1, 6], [5, 7], [5, 9], [1, 11], [0, 19], [3, [17], respectively. This type of nodes only has high dominance over its surrounding adjacent nodes. In actual scenarios, they correspond to some relatively peripheral but important points, such as positions nearby the joints between tunnel walls and the ground. All nodes are independence node except the second-order dominance nodes and the nodes within the two adjacent grids nearby, as well as the first-order dominance nodes and the nodes within one adjacent grid nearby. Above the connection structure layer, the structural health state is assessed and the risk coefficient of each node is calculated. FIG. 3B, FIG. 3C, and FIG. 3D respectively show the case where the entire tunnel section is relatively safe and two cases where the risk coefficient gradually increases on the right side of the section, where the colors of grid points reflect their risk coefficients and the color gradually changes from green to deep red as the risk coefficient increases. Under the safe case, all nodes with second-order dominance may cover a relatively large neighborhood area near them, while nodes with first-order dominance may cover nodes in their smaller neighborhood area nearby. At this time, the covered nodes are in a dormant state, and the health states of the dominance nodes represent that of the entire covered area, thus reducing energy consumption under normal conditions. When the risk coefficient increases to a certain extent, the second-order dominance nodes located in the area where the risk coefficient increases are reduced to cover only their first-order neighborhood area, and nodes farther away from the dominance nodes are awakened to independently monitor the condition at that position, thus strengthening the monitoring of the area. When encountering cases such as regional construction or geological changes near some tunnels, the risk coefficient keeps increasing to a relatively high level, all dormant nodes on the right side are awakened to enhance the monitoring of the area. As shown in FIG. 3D, the risk coefficients of all the grid points on the right side are calculated, and there are differences in the risk coefficients between different points; and, the relatively safer area on the left side still maintains a high coverage range of dominance nodes and remains in a low-energy-consumption working state.

The embodiments of the present disclosure employ a temporal convolutional network and a dimensionally isolated graph attention network to construct spatiotemporal correlations, and uses a conditional variational autoencoder to perform data fusion, and simultaneously proposes a multi-granularity perceptual map adjustment strategy to adapt to monitoring requirements under different safety conditions, thereby achieving the effects of energy saving. The present disclosure can effectively perform structural health assessments, featuring high accuracy, intuitiveness, and low energy consumption, extending the service life of sensor networks. Furthermore, the present disclosure further proposes a multi-granularity perceptual map adjustment strategy, allowing for dynamic adjustment of monitoring granularity according to the actual monitoring requirements, and further improving the flexibility and adaptability of monitoring.

FIG. 4 is a block diagram of a skin-like structure-based intelligent monitoring system for infrastructure according to an exemplary embodiment, and the system is used for implementing the skin-like structure-based intelligent monitoring method for infrastructure. Referring to FIG. 4, the system includes a data base layer 410, a connection structure layer 420, and a pathological manifestation layer 430. In the above,
the data base layer 410 is used to acquire infrastructure data from multiple sensor nodes in the sensor network;
the connection structure layer 420 is used to construct a spatiotemporal correlation model according to the infrastructure data from the multiple sensor nodes, and distinguish the property of each of the sensor nodes in the sensor network according to the spatiotemporal correlation model; and
the pathological manifestation layer 430 is used to input the temporal feature and spatial feature of the spatiotemporal correlation model into the conditional variational autoencoder (CVAE) model to determine the risk coefficient of each sensor node; and perform visualization processing on the structural health state of the infrastructure according to the risk coefficient of each sensor node, and adjust the infrastructure monitoring work of the sensor network according to the risk coefficient of each sensor node and the property of each sensor node.

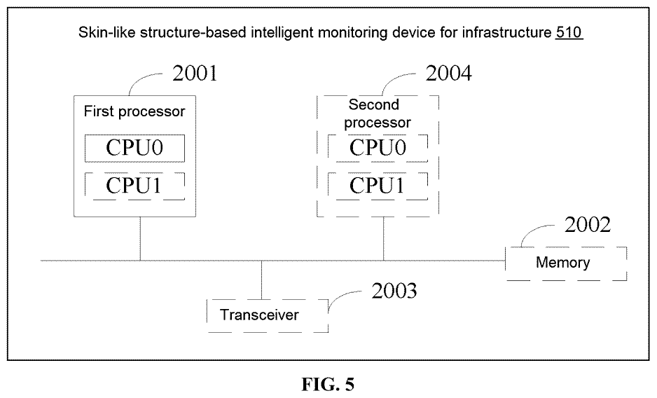

FIG. 5 is a structural schematic view of a skin-like structure-based intelligent monitoring device for infrastructure provided in embodiments of the present disclosure. As shown in FIG. 5, the skin-like structure-based intelligent monitoring device for infrastructure may include the skin-like structure-based intelligent monitoring system for infrastructure as shown in FIG. 4 above. Optionally, the skin-like structure-based intelligent monitoring device 510 for infrastructure may include a first processor 2001.

Optionally, the skin-like structure-based intelligent monitoring device 510 for infrastructure may further include a memory 2002 and a transceiver 2003.

In the above, the first processor 2001 may be connected with the memory 2002, and transceiver 2003 via a communication bus, for example.

The components of the skin-like structure-based intelligent monitoring device 510 for infrastructure are specifically introduced below in conjunction with FIG. 5.

In the above, the first processor 2001 is the control center of the skin-like structure-based intelligent monitoring device 510 for infrastructure. It may be a single processor or a general term for multiple processing elements. For example, the first processor 2001 is embodied as one or more central processing units (CPUs), or may also be an application specific integrated circuit (ASIC), or one or more integrated circuits configured to implement the embodiments of the present disclosure, for example, one or more digital signal processors (DSPs), or one or more field programmable gate arrays (FPGAs).

Optionally, the first processor 2001 may perform various functions of the skin-like structure-based intelligent monitoring device 510 for infrastructure by running or executing software programs stored in the memory 2002 and calling data stored in the memory 2002.

In a specific implementation, as one embodiment, the first processor 2001 may include one or more CPUs, for example, CPU0 and CPU1 shown in FIG. 5.

In a specific implementation, as one embodiment, the skin-like structure-based intelligent monitoring device 510 for infrastructure may also include multiple processors, for example, the first processor 2001 and the second processor 2004 shown in FIG. 5. Each of these processors may be a single-core processor (single-CPU) or a multi-core processor (multi-CPU). The processor herein may refer to one or more devices, circuits, and/or processing cores for processing data (e.g., computer program instructions).

In the above, the memory 2002 is configured to store the software program for executing the solution of the present disclosure, and its execution is controlled by the first processor 2001. The specific implementation may be referred to the above method embodiments, and details are not described herein again.

Optionally, the memory 2002 may be a read-only memory (ROM) or other type of static storage device capable of storing static information and instructions, a random access memory (RAM) or other type of dynamic storage device capable of storing information and instructions, or an electrically erasable programmable read-only memory (EEPROM), a compact disc read-only memory (CD-ROM) or other optical disc storage, optical disc storage (including compressed optical disc, laser disc, optical disc, digital universal optical disc, Blu-ray disc, etc.), magnetic disk storage medium or other magnetic storage device, or any other medium capable of carrying or storing desired program code in the form of instructions or data structures and accessible by a computer, but not limited thereto. The memory 2002 may be integrated with the first processor 2001 or may exist independently and be coupled to the first processor 2001 through the interface circuit (not shown in FIG. 5) of the skin-like structure-based intelligent monitoring device 510 for infrastructure. The embodiments of the present disclosure do not specifically limit this.

The transceiver 2003 is used to communicate with network device(s) or with terminal device(s).

Optionally, the transceiver 2003 may include a receiver and a transmitter (not shown separately in FIG. 5), where the receiver is used to implement the receiving function, and the transmitter is used to implement the transmitting function.

Optionally, the transceiver 2003 may be integrated with the first processor 2001 or exist independently, and be coupled to the first processor 2001 through the interface circuit (not shown in FIG. 5) of the skin-like structure-based intelligent monitoring device 510 for infrastructure. The embodiments of the present disclosure do not specifically limit this.

It should be noted that the structure of the skin-like structure-based intelligent monitoring device 510 for infrastructure shown in FIG. 5 does not constitute a limitation on the router. The actual knowledge structure recognition device may include more or fewer components than those shown in the figures, or be combined with certain components, or have different component arrangements.

In addition, for the technical effects of the skin-like structure-based intelligent monitoring device 510 for infrastructure, reference may be made to the technical effects of the skin-like structure-based intelligent monitoring method for infrastructure described in the above method embodiments, and details are not described herein again.

It should be understood that the first processor 2001 in the embodiments of the present disclosure may be a central processing unit (CPU), and the processor may also be other general-purpose processor, digital signal processor (DSP), application specific integrated circuit (ASIC), field programmable gate array (FPGA), or other programmable logic device, discrete gate or transistor logic device, discrete hardware component, etc. The general-purpose processor may be a microprocessor or the processor may also be any conventional processor, etc.

It should also be understood that the memory in the embodiments of the present disclosure may be volatile memory or non-volatile memory, or may include both volatile and non-volatile memories. In the above, the non-volatile memory may be read-only memory (ROM), programmable read-only memory (PROM), erasable programmable read-only memory (EPROM), electrically erasable programmable read-only memory (EEPROM), or flash memory. The volatile memory may be random access memory (RAM), which is used as an external cache. By way of example and without limitation, many forms of random access memory (RAM) are available, such as static RAM (SRAM), dynamic RAM (DRAM), synchronous DRAM (SDRAM), double data rate synchronous DRAM (DDR SDRAM), enhanced synchronous DRAM (ESDRAM), synchronous connection dynamic random access memory (synchlink DRAM, SLDRAM), and direct memory bus random access memory (direct rambus RAM, DR RAM).

The above embodiments may be implemented, in whole or in part, by software, hardware (such as circuits), firmware, or any other combination. When implemented by using software, the above embodiments may be implemented, in whole or in part, in the form of a computer program product. The computer program product includes one or more computer instructions or computer programs. When the computer instructions or computer programs are loaded or executed on a computer, all or part of the processes or functions described in the embodiments of the present disclosure are generated. The computer may be a general-purpose computer, a special purpose computer, a computer network, or other programmable system. The computer instructions may be stored in a computer-readable storage medium or transmitted from one computer-readable storage medium to another computer-readable storage medium. For example, the computer instructions may be transmitted from one website site, computer, server, or data center to another website site, computer, server, or data center via wired (e.g., infrared, wireless, microwave, etc.) manner. The computer-readable storage medium may be any available medium that may be accessed by a computer, or a data storage device such as a server or a data center that includes one or more sets of available media. The available media may be magnetic media (for example, floppy disks, hard disks, magnetic tapes), optical media (for example, DVDs), or semiconductor media. The semiconductor media may be solid-state drives.

It should be understood that the term “and/or” in the present disclosure is merely a description of the associative relationship between related objects, indicating that three relationships may exist. For example, A and/or B may represent: A existing alone, A and B existing simultaneously, and B existing alone, where A and B may be singular or plural. Additionally, the character “/” herein generally indicates an “or” relationship between the preceding and following related objects, but it may also represent an “and/or” relationship. The specific meaning may be understood by referring to the context.

In the present disclosure, “at least one” means one or more, and “multiple” means two or more than two. “At least one of the following items (entries)” or similar expression refers to any combination of these items, including any combination of a single item (entry) or multiple items (entries). For example, at least one of a, b, or c may represent: a, b, c, a-b, a-c, b-c, or a-b-c, where a, b, and c may be a single entry or multiple entries.

It should be understood that, in various embodiments of the present disclosure, the serial number of the above-mentioned processes does not imply the execution sequence. The execution sequence of each process should be determined by its function and internal logic, and should not constitute any limitation on the implementation process of the embodiments of the present disclosure.

Those ordinary skilled in the art may recognize that the units and algorithm steps of the various examples described in conjunction with the embodiments disclosed herein may be implemented in electronic hardware, or a combination of computer software and electronic hardware. Whether these functions are implemented in hardware or software depends on the specific applications and design constraints of the technical solutions. Those skilled in the art may use different method to implement the described function for each specific application, but such implementation should not be considered beyond the scope of the present disclosure.

Those skilled in the art may clearly understand that for the convenience and conciseness of description, the specific working processes of the devices, systems, and units described above may be referred to the corresponding processes in the foregoing method embodiments, and details are not described herein again.

In the several embodiments provided by the present disclosure, it should be understood that the disclosed devices, systems, and methods may be implemented in other ways. For example, the system embodiments described above are merely illustrative. For instance, the division of units is only a logical functional division, and in actual implementation, there may be other division methods. For example, multiple units or components may be combined or integrated into another device, or some features may be ignored or not executed. Another point is that displayed or discussed mutual coupling or direct coupling or communication may be achieved through some interfaces, and indirect coupling or communication between systems or units may be in the electrical, mechanical or other form.

The units described as separate components may or may not be physically separated, and the components displayed as units may or may not be physical units; that is, they may be located in one place or distributed across multiple network units. Some or all of the units may be selected according to actual needs to achieve the purpose of the embodiments.

In addition, each functional unit in the various embodiments of the present disclosure may be integrated into a single processing unit, may also exist as a separate physical unit individually, or may have two or more units integrated into one unit.

If the function is implemented in the form of a software functional unit and sold or used as an independent product, it may be stored in a computer-readable storage medium. Based on this understanding, the technical solutions of the present disclosure, or the part that contributes to the prior art, or a part of the technical solution, may be embodied in the form of a software product. The computer software product is stored in a storage medium and includes several instructions to cause a computer device (which may be a personal computer, server, or network device, etc.) to execute all or part of the steps of the methods described in the various embodiments of the present disclosure. While the aforementioned storage medium includes various media capable of storing program code, such as USB flash drives, portable hard drives, read-only memory (ROM), random access memory (RAM), magnetic disks, or optical disks.

The above are merely specific embodiments of the present disclosure, but the scope of protection of the present disclosure is not limited thereto. Any variations or substitutions that may be easily conceived by those skilled in the art within the technical scope disclosed in the present disclosure should be included within the scope of protection of the present disclosure. Therefore, the scope of protection of the present disclosure should be determined by the scope of protection of the claims.

1. A skin-like structure-based intelligent monitoring method for infrastructure, comprising:
S1. acquiring infrastructure data from multiple sensor nodes in a sensor network;
S2. constructing a spatiotemporal correlation model according to the infrastructure data from the multiple sensor nodes, and distinguishing a property of each of the sensor nodes in the sensor network according to the spatiotemporal correlation model;
S3. inputting a temporal feature and a spatial feature of the spatiotemporal correlation model into a conditional variational autoencoder (CVAE) model to determine a risk coefficient of each sensor node; and
S4. performing visualization processing on a structural health state of the infrastructure according to the risk coefficient of each sensor node, and adjusting infrastructure monitoring work of the sensor network according to the risk coefficient of each sensor node and the property of each sensor node,
wherein the constructing the spatiotemporal correlation model according to the infrastructure data from the multiple sensor nodes and distinguishing the property of each of the sensor nodes in the sensor network according to the spatiotemporal correlation model in S2 comprises:
S21. constructing the spatiotemporal correlation model according to the infrastructure data from the multiple sensor nodes, by using a method combining a temporal convolutional network and a dimensionally isolated graph attention network;
S22. determining an affiliation value and a dominance value of each sensor node according to attention coefficients between nodes in the spatiotemporal correlation model and information of adjacent nodes of each sensor node, and distinguishing dominance nodes, affiliation nodes, and independence nodes in the sensor network;
wherein the constructing the spatiotemporal correlation model according to the data from the multiple sensor nodes by using a method combining a temporal convolutional network and a dimensionally isolated graph attention network in S21 comprises:
generating time series data according to the data from the multiple sensor nodes, inputting the time series data to the temporal convolutional network, and capturing temporal feature vectors at different time scales through multiple causal convolution layers in the temporal convolutional network; and
combining the temporal feature vectors with original spatial data in the data from the multiple sensor nodes to obtain a new feature matrix, inputting the new feature matrix into the dimensionally isolated graph attention network, calculating weights between nodes according to a multi-head attention mechanism in the graph attention network, and calculating attention coefficients between each node and all adjacent nodes thereof, thereby obtaining spatiotemporal correlation between nodes;
wherein the inputting the temporal feature and the spatial feature of the spatiotemporal correlation model into the conditional variational autoencoder (CVAE) model to determine the risk coefficient of each sensor node in S3 comprises:
S31. obtaining time series data according to the temporal feature and the spatial feature of the spatiotemporal correlation model, and generating input information in a preset format according to the time series data, wherein the preset format is (sensor ID, time, data type);
S32. inputting the input information to a trained conditional variational autoencoder (CVAE) model, and determining a risk coefficient of a corresponding sensor node according to an output latent variable, wherein the latent variable is used to characterize a mechanical property, a material strength property and a dynamic characteristic of a foundation structure in different dimensions; and
wherein the adjusting infrastructure monitoring work of the sensor network according to the risk coefficient of each sensor node and the property of each sensor node in S4 comprises:
determining, when the risk coefficient of each sensor node in the sensor network is less than a preset risk threshold value, that all areas of the infrastructure are in a safety state at a current moment, maintaining activated states of the dominance nodes and the independence nodes, and putting the affiliation nodes into a dormant state; and
determining, when risk coefficients of some sensor nodes in the sensor network are greater than or equal to the preset risk threshold value, that some areas of the infrastructure are in a dangerous state at the current moment, activating affiliation nodes dominated by dominance nodes in the dangerous state, activating affiliation nodes in the dangerous state, and maintaining activated state of independence nodes in the dangerous state.

2. The skin-like structure-based intelligent monitoring method for infrastructure according to claim 1, wherein the determining the affiliation value and the dominance value of each sensor node according to the attention coefficients between the nodes in the spatiotemporal correlation model and the information of the adjacent nodes of each sensor node and distinguishing the dominance nodes, the affiliation nodes, and the independence nodes in the sensor network in S2 comprises:
S221. calculating a first-order affiliation value of an i-th sensor node in the sensor network according to a following formula (1), and calculating a first-order dominance value of the i-th sensor node according to a following formula (2):
$$aff {( i )}_{1} = \frac{{\sum }_{j = 0}^{N} {α}_{ij}}{N} \qquad ( 1 )$$
$$dom {( i )}_{1} = \frac{{\sum }_{j = 0}^{N} {α}_{ji}}{N} \qquad ( 2 )$$
wherein aff(i)₁ indicates the first-order affiliation value of the i-th sensor node in the sensor network, αᵢⱼ indicates an attention coefficient between the i-th sensor node and a j-th sensor node in the sensor network, wherein i is not equal to j, N indicates a total number of first-order adjacent nodes of the i-th sensor node, dom(i)₁ indicates a first-order dominance value of the i-th sensor node in the sensor network, and αⱼᵢ indicates an attention coefficient between the j-th sensor node and the i-th sensor node; and
S222. determining the i-th sensor node as the affiliation node, if the first-order affiliation value of the i-th sensor node is greater than or equal to a first attribute threshold value; determining the i-th sensor node as the dominance node, if the first-order dominance value of the i-th sensor node is greater than or equal to a second attribute threshold value; and determining the i-th sensor node as the independence node, if the first-order affiliation value of the i-th sensor node is less than the first attribute threshold value and the first-order dominance value is less than the second attribute threshold value.

3. The skin-like structure-based intelligent monitoring method for infrastructure according to claim 1, wherein a training process of the conditional variational autoencoder (CVAE) model comprises:
acquiring a training sample, wherein the training sample comprises infrastructure-related sample input data and label information corresponding to the sample input data; and
inputting the sample input data to a CVAE model to be trained, to obtain corresponding mean and variance of the sample input data, determining the latent variable according to the mean and variance, comparing the latent variables with the label information corresponding to the sample input data and calculating a loss function, and adjusting parameters in the CVAE model to be trained, performing iterative execution until the loss function converges, and stopping training to obtain the trained conditional variational autoencoder (CVAE) model.

4. A skin-like structure-based intelligent monitoring system for infrastructure, wherein the skin-like structure-based intelligent monitoring system for infrastructure is configured to implement the skin-like structure-based intelligent monitoring method for infrastructure according to claim 1, and the system comprises a data base layer, a connection structure layer, and a pathological manifestation layer, wherein:
the data base layer is configured to acquire the infrastructure data from the multiple sensor nodes in the sensor network;
the connection structure layer is configured to construct the spatiotemporal correlation model according to the infrastructure data from the multiple sensor nodes, and distinguish the property of each sensor node in the sensor network according to the spatiotemporal correlation model; and
the pathological manifestation layer is configured to input the temporal feature and the spatial feature of the spatiotemporal correlation model to the conditional variational autoencoder (CVAE) model to determine the risk coefficient of each sensor node, perform the visualization processing on the structural health state of the infrastructure according to the risk coefficient of each sensor node, and adjust the infrastructure monitoring work of the sensor network according to the risk coefficient of each sensor node and the property of each sensor node.

5. A skin-like structure-based intelligent monitoring device for infrastructure, wherein the skin-like structure-based intelligent monitoring device for infrastructure comprises:
a processor; and
a memory, wherein the memory stores computer-readable instructions, when the computer-readable instructions are executed by the processor, the method according to claim 1 is implemented.

6. A computer-readable storage medium, wherein the computer-readable storage medium stores program codes, and the program codes can be called and executed by the processor to perform the method according to claim 1.
